(19) United States
(12) Patent Application Publication
(10) Pub. No.: US 2008/0163978 A1
(43) Pub. Date: Jul. 10, 2008

(54) Process for producing multi-layer structures having improved metal adhesion

(76) Inventor: Maged G. Botros, West Chester, OH (US)

Correspondence Address: WILLIAM A. HEIDRICH;EQUISTAR CHEMICALS, LP, 11530 Northlake Drive, Cincinnati, OH, 45249, US

(21) Appl. No.: 11/651,265

(22) Filed: Jan. 9, 2007

(51) Int. Cl. C09J 5/06

(52) U.S. Cl. 156/313; 264/177.1

(57) ABSTRACT

Extrusion and lamination processes are provided for producing multi-layer constructions wherein metal and polyolefin layers are bonded through a tie-layer comprising a base resin and two functionalized ethylene polymers.

### FIELD OF THE INVENTION

The invention relates to extrusion and lamination processes for producing multi-layer structures. More specifically, multi-layer structures wherein one of the layers is a metal are produced by the process of the invention which utilizes an adhesive blend composition comprising two functionalized ethylene polymers and a base resin.

### DESCRIPTION OF THE PRIOR ART

Adhesive blends, sometimes referred to as tie-layer adhesives, are widely used to bond dissimilar substrates, e.g., polar polymer substrates to non-polar polymer substrates. Another common application is for bonding polyolefins to metals. These adhesive blends typically have a polyolefin base resin as the major constituent and a modified polyolefin containing acid or acid derivative functionality as a minor constituent. Additional constituents, e.g., elastomeric materials, are often included in the adhesive blends for certain applications.

Bonding of metals and polyolefins can be accomplished by either extrusion or lamination. With the former, a layer of the adhesive composition is extruded between the metal and polyolefin layers. The polyolefin may be applied as a pre-formed film or it may be coextruded. For lamination procedures, a film of the adhesive blend is placed between the metal and polyolefin layers being bonded and the assemblage exposed to heat and pressure, generally by passing between heated rolls, to effect adhesion.

Applications wherein polyolefins are bonded to various metals by extrusion or lamination are numerous and varied. Food packaging, pipe coating and structural panels are examples of these diverse applications. Depending on the particular application involved and whether the adhesive is extruded or laminated, process conditions and adhesive requirements will vary. For example, high speed extrusion lines typically operate at high temperatures whereas lamination processes, such as those used for the production of metal panels, are carried out at much lower temperatures.

As a result, adhesive blends which provide good adhesion over a broad temperature range are in high demand and it would be highly advantageous if a process were available wherein improved metal/polyolefin adhesion could be obtained under a variety of conditions. These and other advantages are realized with the process of the present invention which utilizes an adhesive blend containing a polyolefin base resin and a combination of functionalized polyolefins, namely, a polyolefin grafted with maleic anhydride and an ethylene polymer having acrylic acid or methacryclic acid copolymerized or grafted.

International Publication Number WO96/38302 discloses protective coatings for metal surfaces comprising an adhesive layer to bond a protective film to the metal substrate. The reference discloses that the adhesive film can consist of two layers—the first being a copolymer of ethylene and acrylic acid and the second being a blend of polyethylene and maleic anhydride. It does not, however, disclose that the polymer components comprising the individual layers can be combined and extruded as a single layer or that the maleic anhydride be reacted with the polyethylene prior to extrusion.

### SUMMARY OF THE INVENTION

The present invention is directed to extrusion and lamination processes for producing multi-layer structures having at least one metal layer bonded to a polyolefin layer through an intermediate tie-layer comprised of a combination of two functionalized ethylene polymers and a base resin. More specifically, the process of the invention comprises providing a first functionalized ethylene polymer component having an α,β-ethylenically unsaturated carboxylic acid incorporated by grafting or copolymerization and a second functionalized ethylene polymer component having maleic anhydride incorporated by grafting, combining said first and second functionalized ethylene polymer components with a base resin selected from the group consisting of ethylene homopolymers, copolymers of ethylene and C₃₋₈ α-olefins and copolymers of ethylene and vinyl esters of C₂₋₄ aliphatic acids to form a tie-layer adhesive composition containing 10 to 90 weight percent base resin and 90 to 10 weight percent of the combination of said first and second functionalized ethylene polymers present at a weight ratio of 8:1 to 1.5:1 and then melt blending the tie-layer adhesive composition. Depending on the particular process involved, the melt-blend is then either directly extruded to form a multi-layer structure or formed into a film which is subsequently used to form a multi-layer structure by lamination.

In one preferred embodiment of the invention, the first functionalized ethylene polymer has 3 to 18 weight percent acrylic acid or methacrylic acid incorporated by grafting or copolymerization and the second functionalized ethylene polymer is high density polyethylene or linear low density polyethylene grafted with 0.1 to 5 weight percent maleic anhydride. In another preferred embodiment the base resin is low density polyethylene having a density from 0.917 to 0.925 g/cm³ and melt index from 3 to 20 g/10 min.

### DETAILED DESCRIPTION OF THE INVENTION

The present invention relates to extrusion and lamination processes whereby multi-layer structures having at least one metal layer bonded to at least one polyolefin layer are produced. The processes utilize adhesive blends obtained by combining two functionalized ethylene polymer components with a polyolefin base resin as the tie-layer for the metal and polyolefin layers.

For extrusion, the process involves combining a first functionalized ethylene polymer component having an α,β-ethylenically unsaturated carboxylic acid incorporated by grafting or copolymerization and a second functionalized ethylene polymer component having maleic anhydride incorporated by grafting at a weight ratio ranging from 8:1 to 1.5:1, with the polyolefin base resin to form a tie-layer adhesive composition containing 10 to 90 weight percent of a mixture of said first and second functionalized ethylene polymer components and 90 to 10 weight percent base resin, melt blending the adhesive composition, and extruding the melt blended adhesive composition to form a multi-layer construction wherein the tie-layer adhesive is disposed between a metal layer and a polyolefin layer. For lamination, the melt blended tie-layer adhesive composition is formed into a film and the film disposed between the metal and polyolefin layers which are then adhesively bonded by the application of heat.

Two different functionalized components are employed for the adhesive blends used for the process of the invention. The first functionalized component is an ethylene-α,β-ethylenically unsaturated carboxylic acid copolymer produced by copolymerization or grafting and referred to herein as the acid copolymer. Acid copolymers produced by direct copolymerization of ethylene and α,β-ethylenically unsaturated carboxylic acid comonomers and by grafting α,β-ethylenically unsaturated carboxylic acids onto preformed ethylene polymer backbones are well known and available from commercial sources. Whereas such copolymers can be produced using C₃₋₈ α,β-unsaturated carboxylic acids, acid copolymers employed for the present process are preferably copolymers of ethylene and acrylic acid or ethylene and methacrylic acid. Acid comonomer contents can range from 3 to 18 weight percent (wt. %) but, more preferably, are in the range 5 to 12 wt. %, based on the total weight of the acid copolymer.

Acid copolymers of the above types useful for the process of the invention are available from commercial sources. For example, ethylene-acrylic acid copolymers having acrylic acid contents ranging from 6.5 to 9.7 wt. % and melt indexes (MIs) ranging from 1.5 to 20 g/10 min are available from the Dow Chemical Company under the trademark PRIMACOR. Ethylene-methacrylic acid and ethylene-acrylic acid copolymers having acid contents from 4 to 18 wt. % and MIs from 3 to 450 g/min are also available from EI DuPont de Nemours and Company under the trademark NUCREL. Acid copolymers employed for the process of the invention preferably have MIs from 0.5 to 100 g/10 min and, most preferably, from 1 to 50 g/10 min. MIs referred to herein are determined in accordance with ASTM D 1238, condition 190/2.16, unless otherwise indicated.

The second functionalized ethylene polymer component is a maleic anhydride-functionalized polyolefin produced by grafting maleic anhydride (MAH) onto a polyolefin, e.g., polyethylene (PE). The grafting may be accomplished using known procedures in solution, in a fluidized bed reactor, by melt grafting or by irradiation grafting. As used herein, the term grafting denotes covalent bonding of the grafting monomer to the polymer chain.

Highly useful MAH-functionalized polyolefins are conveniently prepared by grafting in the substantial absence of solvent. This can be accomplished in a shear-imparting reactor, such as an extruder/reactor. Twin screw extruder/reactors such as those manufactured by Coperion under the designations ZSK-53, ZSK-83 and ZSK-92 are commonly used. Free radical initiators, such as organic peroxides, can be employed but are not necessary.

The graft monomer, i.e., MAH, concentration in the reactor is typically about 1 to about 7.5 wt. % based on the total weight of the reaction mixture. A temperature profile where the temperature of the polymer melt is gradually increased in the extruder/reactor up to a maximum in the grafting reaction zone and then decreases toward the reactor exit is preferred. The maximum temperature in the reactor should be such that significant vaporization losses and/or premature decomposition of any initiator used are avoided. For example, if di-t-butyl peroxide and 2,5-dimethyl-2,5-di-(t-butylperoxy)hexane are used, temperatures within the reactor are maintained at or below about 220° C.

Examples of other useful peroxides which can be used for the grafting operation include: 1,1-bis(t-butylperoxy)cyclohexane; n-butyl-4,4-bis(t-butylperoxy-valerate); 1,1-bis(t-butylperoxy)-3,3,5-trimethylcyclohexane; 2,2-bis(t-butyl-peroxy)butane; dicumylperoxide; t-butylcumylperoxide; α,α′-bis(t-butylperoxy-preoxy-isopropyl)benzene; di-t-butylperoxide; and the like. The MAH and any catalyst used are preferably added in neat form to the extruder/reactor.

Polyolefins grafted with MAH in accordance with the above procedures include homopolymers and copolymers of ethylene and propylene or mixtures thereof. Particularly useful are ethylene homopolymers and copolymers of ethylene with C₃₋₈ α-olefins. Graft monomer contents, i.e., the amount of MAH reacted with the polyolefin, generally range from about 0.1 up to about 5 wt. %. Highly useful modified polyolefins for the invention have from 0.5 to 4 wt. % MAH grafted. In one highly useful embodiment of the invention, the second functionalized ethylene polymer component is high density polyethylene (HDPE) or linear low density polyethylene (LLDPE) grafted with MAH. The MI of the MAH-functionalized grafted component typically ranges from 1 to 20 g/10 min., and more preferably, is in the range 5 to 10 g/10 min.

Base resins combined with the above-described first and second functionalized components to obtain the adhesive blend compositions utilized for the process of the invention are ethylene homopolymers and copolymers of ethylene with C₃₋₈ α-olefins or vinyl esters of C₂₋₄ aliphatic acids produced by known polymerization procedures utilizing Ziegler, Phillips, metallocene or free radical catalysts. Metallocene single-site catalysts are transition metal compounds that contain cyclopentadienyl (Cp) or Cp derivative ligands (see U.S. Pat. No. 4,542,199). Non-metallocene single-site catalysts contain ligands other than Cp, usually heteroatomic ligands, e.g., boraaryl (see U.S. Pat. No. 6,034,027), pyrrolyl (see U.S. Pat. No. 5,539,124), azaborolinyl (see U.S. Pat. No. 5,756,611) and quinolinyl (see U.S. Pat. No. 5,637,660). Single-site catalysts typically produce polyethylenes having narrower molecular distributions.

Ethylene homopolymers, ethylene-C₄₋₈ α-olefin copolymers wherein the α-olefin comonomer or mixture of comonomers comprises 0.1 to 15 wt. % of the copolymer composition and ethylene-vinylacetate (EVA) copolymers wherein the vinyl acetate (VA) content is from 5 to 28 wt. % are particularly useful base resins. MIs of these base resin ethylene polymers can range from 0.1 to 100 g/10 min and densities can range from 0.865 to 0.935 g/cm³; however, MIs and densities are more typically in the range 2 to 35 g/10 min and 0.912 to 0.925 g/cm³, respectively. In one highly useful embodiment, the ethylene-α-olefin copolymer is a copolymer of ethylene with 0.1 to 7.5 wt. % butene-1, hexene-1 or octene-1 and the EVA copolymer has a VA content of 12 to 28 wt. %.

Highly useful for the present process are adhesive blends wherein the base resin is low density polyethylene (LDPE) having an MI preferably range from 3 to 20 g/10 min and density in the range 0.917 to 0.925 g/cm³.

The base resin and first and second functionalized components are typically dry-blended at the desired weight ratio and then melt blended by conventional means, such as in an extruder or Banbury mixer. The resulting melt blended composition may be directly extrusion coated onto the substrate or cast into a film suitable for lamination or the blend may be pelletized and stored for subsequent extrusion coating or lamination.

The first and second functionalized ethylene polymer components are combined with the base resin so that the functionalized ethylene polymers comprise from 10 to 90 wt. % of the adhesive blend and the base resin constitutes from 90 to 10 wt. % of the blend. The weight ratio of first to second functionalized component ranges from 8:1 to 1.5:1 and, more preferably, is in the range 5:1 to 2:1. In a highly useful embodiment of the invention, the adhesive blend contains 80 to 20 wt. % base resin and 20 to 80 wt. % of a mixture of functionalized ethylene polymers. In a preferred embodiment of the process the adhesive blend used is comprised of 40 to 60 wt. % first and second functionalized ethylene polymers present at a weight ratio of from 5:1 to 2:1.

For most applications the adhesive blends will also contain one or more additives such as thermal stabilizers, antioxidants, UV inhibitors, processing aids, adhesion promotors and the like. These are commonly employed at very low levels, e.g., 50 to 10000 ppm.

Additionally, one or more elastomers or plastomers may be included with the base resin component. These elastomers which typically contain less than 30 wt. % crystallinity include, for example, ethylene-propylene copolymer rubbers (EPRs), ethylene-propylene-diene terpolymer rubbers (EPDMs), chlorinated copolymers of isobutylene and isoprene, copolymers of butadiene and styrene, copolymers of isoprene and styrene, block copolymers butadiene and styrene, block copolymers of isoprene and styrene, block copolymers of isoprene and vinyl toluene, hydrogenated block copolymers of butadiene and styrene, hydrogenated block copolymers of isoprene and styrene, copolymers of acrylonitrile and butadiene, copolymers of methacrylonitrile and butadiene, copolymers of acrylonitrile and isoprene, copolymers of methacrylonitrile and isoprene, ethylene-vinyl acetate copolymers and the like. EPRs and EPDMs are particularly useful elastomers.

Plastomers which can be employed for the blends are produced using metallocene or “single site” catalysts having at least one cyclopentadienyl or analogous ligand coordinated to a transition metal cation. Metallocene catalysts and polymerization processes are described in U.S. Pat. Nos. 5,017,714 and 5,324,820 which are incorporated herein by reference. Plastomers which can be used include copolymers of ethylene and C₄₋₈ α-olefin comonomers wherein ethylene comprises from about 87 to about 97.5 mole % and the α-olefin comprises about 2.5 to 13 mol % of the plastomer. Plastomers typically have densities from 0.85 to 0.92 g/cm³. Most preferably, plastomer densities will be from 0.86 to 0.90 g/cm³. Copolymers of ethylene and butene-1, hexene-1 and octene-1 are particularly useful plastomers. Plastomer copolymers of the above type are commercially available and are described in more detail in U.S. Pat. No. 6,207,754 which is incorporated herein by reference.

When present, the elastomers and/or plastomers will typically comprise less than 20 wt. % of the adhesive blend and, most generally, constitute less than 15 wt. % of the adhesive blend.

While the above-described adhesive blends are highly versatile and can be utilized for bonding widely diverse materials, such as wood, glass, paper, and composite materials, they are particularly well suited for bonding polyolefins and metals such as aluminum, steel, copper, brass, stainless steel, galvanized steel and the like. They are highly useful as tie-layers in processes for the manufacture of multi-layer constructions wherein a polyolefin is “sandwiched” between two layers of metal. Structures of this type, e.g., metal/adhesive/polyolefin/adhesive/metal, are widely used for construction panels, truck panels, signage and the like, particularly where the polyolefin is polyethylene.

They are also highly useful as tie-layers in process for the production of polyolefin/metal composite pipe and tubing. These are multi-layer constructions, most typically, five-layer composites of polyolefin/adhesive/metal/adhesive/polyolefin. Constructions of this type are used for a wide variety of heating and plumbing applications including, for example, hot and cold potable water installations, radiant floor heating systems, snow and ice melting systems for walks and driveways, compressed air supply lines, radiator connections and industrial and sanitary applications.

Crosslinked polyethylene (PEX) and aluminum are commonly used for these applications, but copper and conventional PE are also utilized by some manufacturers. These constructions would have the structure PEX/adhesive/metal/adhesive/PEX, PEX/adhesive/metal/adhesive/PE or PE/adhesive/metal/adhesive/PE. Even though the metal provides most of the mechanical strength in these constructions, mechanical integrity and pressure ratings are dependent on the quality of the bond between the metal and PE or PEX. Failure of the bond results in delamination at the metal/tie-layer interface and severely detracts from the service life of the pipe.

The process of the invention can also be utilized for bonding layers of polymers. This can be accomplished by coextrusion, extrusion lamination, heat sealing or by any other methods used to adhere dissimilar polymer substrates, most notably, non-polar polyolefin substrates, e.g., PE, and polar substrates such as polyamides (nylons), ethylene-vinyl alcohol (EVOH) copolymers, polyesters, styrene polymers, polyurethanes and the like. Whereas the above are often flexible structures, the process can also be advantageously employed for rigid and semi-rigid multi-layer polymer constructions. Constructions of this type and which contain one or more structural layers are commonly used for food packaging or food storage applications. A typical construction of this type would comprise one or more food contact or sealing layers, a barrier layer and one or more structural layers.

Food contact/sealing layers often comprise non-polar polyolefins, e.g., LDPE, while typical barrier layers comprise substrates of EVOH, polyamides or the like. Structural layers may comprise styrene polymers which may also contain rubber. High impact polystyrene (HIPS) is widely used as a structural layer, given its desirable physical properties, ease of extrusion processing, thermoforming and cutting. Applications of the latter type include, for example, fabrication of refrigerator liners which require good barrier properties and resistance to stress cracking.

Conventional extrusion techniques are employed for the process of the invention. Equipment and conditions suitable for the manufacture of extrusion or coextrusion of coated metals known to the art can be used. In general, the process involves heating the polymer material(s) being extruded to the desired temperature, usually in an extruder provided with a screw, and forcing the melt through the narrow slit of an extrusion coating die onto the substrate being coated. While in the molten state the coating material is drawn together with the substrate between a pair of rollers forming a nip. The rollers are biased towards each other to effect good contact of the molten coating with the substrate. Normally the roller adjacent the polymer is cooled, for example by water, and the other roller is usually formed of a compressible material such as rubber. The cooled roller is generally maintained at a temperature below that at which the polymer sticks to avoid adhesion to that roller. The gap between the rollers and the speed of rotation of the rollers are varied to control the thickness of the extrusion coating layer and draw ratio. Coextrusion processes for the production of multi-layer extrudates utilize feedblocks which stack melt layers from two or more extruders.

Extrusion coating line speeds may be as high as 3500 ft/min but, more typically, are in the range 400 to 1500 ft/min. Thickness of the extrusion coating can range from 0.4 to 10 mils and, more typically, is from 0.5 to 8 mils. Operating temperatures, i.e., the temperature of the extrusion coating as it exits the die, can range from 400° F. to about 650° F. depending on the particular polymer(s) being used. An advantage of the present process is the ability to operate at lower regions in the temperature range and still obtain good adhesion of the coating to metal substrates.

A comprehensive description of extrusion coating techniques and applications is provided in the technical manual published by Equistar Chemicals, LP entitled “A Guide to Polyolefin Extrusion Coating,” copyright 1997; 664/V308/Reprint 12/97, details of which are incorporated herein by reference. Extrusion coating, as described herein, includes extrusion lamination wherein the adhesive blend composition is extruded between two substrates which then pass through the nip to form a laminated product in which the two substrates are bonded by the intervening extruded tie-layer.

In addition to extruding the adhesive blend onto a metal substrate by itself or with other coextrudates, the adhesive blend can be formed into a film after the functionalized components and base resin are melt blended and the film utilized for a lamination processes. The film is subsequently sandwiched between a layer of metal and a layer of polyolefin and a multi-layer laminate formed by the application of heat and pressure in accordance with conventional procedures. Conventional casting procedures can be used to produce films of the adhesive blends in these operations, the adhesive blend is melted and extruded through a slot die, typically onto a chill roll where it is quenched and solidified. The film is stripped from the chill roll and wound.

The following examples illustrate the process of the invention and the improved metal adhesion obtained by using the polyolefin blends which contain a combination of two functionality ethylene polymer components extrusion coating blends. Those skilled in the art, however, will recognize numerous possible variations which are within the spirit of the invention and scope of the claims.

Adhesive blends used in the examples were prepared by dry-blending the functionalized components and base resin in the specified proportions. The following components were used for the adhesive blends:

| | |
|---|---|
| FEP1P | A functionalized ethylene-acrylic acid polymer (PRIMACOR |
| | 3440); density 0.938 g/cm³; MI 11 g/10 min; 9.7 wt. % |
| | acrylic acid |
| FEP1N | functionalized ethylene methacrylic acid copolymer (NUCREL |
| | 0910); density 0.93 g/cm³; MI 10 g/10 min; 8.7 wt. % |
| | methacrylic acid |
| FEP2 | A functionalized ethylene polymer; HDPE grafted with |
| | 1.9 wt. % MAH; density 0.953 g/cm³. |
| BR1 | An ethylene homopolymer; density 0.918 g/cm³; MI 7 g/10 min. |

The following adhesive blends were prepared utilizing the above-identified components:

| | |
|---|---|
| AB1 | A blend of 40 wt. % FEP1N, 10 wt. % FEP2 and 50 wt. % LDPE |
| | base resin |
| AB2 | A blend of 40 wt. % FEP1P, 10 wt. % FEP2 and 50 wt. % LDPE |
| | base resin |
| AB3 | A blend of 20 wt. % FEP1N, 5 wt. % FEP2 and 75 wt. % LDPE |
| | base resin |
| AB4 | A blend of 16.7 wt. % FEP1N, 8.3 wt. % FEP2 and 75 wt. % |
| | LDPE base resin |

Additionally, comparative adhesive blends were prepared as follows:

| | |
|---|---|
| CAB1 | A blend of 50 wt. % FEP1N and 50 wt. % LDPE base resin |
| CAB2 | A blend of 50 wt. % FEP1P and 50 wt. % LDPE base resin |
| CAB3 | A blend of 25 wt. % FEP1N and 75 wt. % LDPE base resin |

The LDPE base resin used for all of the above-formulated blends (inventive and comparative) was an ethylene homopolymer having a density of 0.918 g/cm3 and MI of 7 g/10 min.

To determine the superior adhesion to metal/metallized substrates achieved by the process of the invention, 5 mil thick films of the adhesive blends were prepared on a standard single screw extruder (L/D 24/1; ¾″ screw; 98 rpm) having a temperature profile of 145° C., 155° C., 160° C. and 170° C. Films produced from various adhesive blends (inventive and comparative) were then evaluated for adhesion to aluminum by heat sealing at different time/temperature conditions to simulate various types of commercial processes. A standard heat sealer was employed at 40 psi. Only the top bar was heated. Films of the adhesive blends were adhered to 5 mil aluminum sheet (A1 1100 from Corus) which was washed with acetone and dried for 30 minutes. A thin TEFLON sheet was placed between the heat sealing bar and the adhesive blend to prevent sticking. Adhesion was measured on 1″ wide strips cut from the heat sealed specimen. Each strip was separated at the adhesive/metal interface by pulling apart in a T-peel configuration at a rate of 10″/min using a tensile tester. Test results reported are the average obtained for three specimens and are reported in lbs/in.

Adhesion was measured for AB1 and CAB2 over the temperature range 350° F. to 500° F. (at 50° F. intervals). A dwell time of 3 seconds was used. Adhesion values obtained were as follows:

| | AB1 | CAB1 |
|---|---|---|
| 350° F. | 0.31 | 0.15 |
| 400° F. | 0.8 | 0.25 |
| 450° F. | 1.55 | 0.51 |
| 500° F. | 1.63 | 0.85 |

It is apparent from the above data that markedly superior adhesion is obtained over the temperature range tested using the process of the invention wherein an adhesive blend containing the two functionalized components is used compared to the process using comparative blend CAB1. Similar improved adhesion is observed when polyethylene film is adhered to the A1 sheet using AB1 as the tie-layer.

In a similar manner, adhesion of AB2 to A1 was determined over the temperature range 350° F. to 500° F. The heat seal time was 3 seconds. Adhesion was also determined for CAB2 using identical test conditions. Adhesion results were as follows:

| | AB2 | CAB2 |
|---|---|---|
| 350° F. | 0.34 | 0.18 |
| 400° F. | 0.84 | 0.46 |
| 450° F. | 1.53 | 0.77 |
| 500° F. | 1.66 | 0.92 |

The above results show that consistently improved metal adhesion is obtained by the inventive process wherein a combination of two different functionalized components are employed with the base resin.

Adhesion of AB1 and AB2 to A1 was also measured at 450° F. and 500° F. using a much shorter (1 second) dwell time. These conditions, i.e., short dwell times and high temperatures, simulate operating conditions of a high speed commercial extrusion coating lines. Adhesion data was also obtained using CAB1 and CAB2 under the same conditions. Results were as follows:

| | |
|---|---|
| AB1 at 450° F. | 0.78 lbs/in |
| AB1 at 500° F. | 1.27 lbs/in |
| AB2 at 450° F. | 0.87 lbs/in |
| AB2 at 500° F. | 1.58 lbs/in |
| CAB1 at 450° F. | 0.27 lbs/in |
| CAB1 at 500° F. | 0.55 lbs/in |
| CAB2 at 450° F. | 0.37 lbs/in |
| CAB2 at 500° F. | 0.55 lbs/in |

To simulate conditions typically used in commercial processes used for the production of laminated panels, films of AB3 and AB4 were laminated to A1 at 375° F. in accordance with the above-described procedures. Adhesion values obtained using AB3 and AB4 for the lamination process were 0.134 and 0.231 lbs/in., respectively. Using the comparative adhesive blend and identical lamination conditions (375° F. and 1 second dwell time), adhesion was only 0.11 lbs/in. When a film comprised solely of the maleic-anhydride functionalized component (FEP2) was employed, using the same lamination conditions, no adhesion to the aluminum substrate was obtained.

I claim:

1. An extrusion process for the production of multi-layer structures comprising:
(a) providing a first functionalized ethylene polymer component having an α,β-ethylenically unsaturated carboxylic acid incorporated by grafting or copolymerization;
(b) providing a second functionalized ethylene polymer component having maleic anhydride incorporated by grafting;
(c) combining (a) and (b) with a base resin selected from the group consisting of ethylene homopolymers, copolymers of ethylene and C₃₋₈ α-olefins and copolymers of ethylene and vinyl esters of C₂₋₄ aliphatic acids to form a tie-layer adhesive composition containing 10 to 90 weight percent of a mixture of said first and second functionalized ethylene polymer components and 90 to 10 weight percent base resin, the weight ratio of (a):(b) in said mixture ranging from 8:1 to 1.5:1;
(d) melt blending the tie-layer adhesive composition; and
(e) extruding the melt blended tie-layer adhesive composition to form a multi-layer construction wherein the adhesive is disposed between a metal layer and a polyolefin layer.

2. The process of claim 1 wherein the first functionalized ethylene polymer has 3 to 18 weight percent acrylic acid or methacrylic acid incorporated by grafting or copolymerization and the second functionalized ethylene polymer is high density polyethylene or linear low density polyethylene grafted with 0.1 to 5 weight percent maleic anhydride.

3. The process of claim 2 wherein the weight ratio of the first functionalized ethylene polymer to the second functionalized ethylene polymer is from 8:1 to 1.5:1.

4. The process of claim 2 wherein the first functionalized ethylene polymer is an ethylene-acrylic acid copolymer having an acrylic acid content of 5 to 12 weight percent and melt index from 1 to 50 g/10 min.

5. The process of claim 2 wherein the first functionalized ethylene polymer is an ethylene-methacrylic acid copolymer having a methacrylic acid content of 5 to 12 weight percent and melt index from 1 to 50 g/10 min.

6. The process of claim 3 wherein the base resin is low density polyethylene having a density from 0.917 to 0.925 g/cm³ and melt index from 3 to 20 g/10 min.

7. The process of claim 6 wherein the base resin comprises 20 to 80 weight percent of the adhesive blend, the functionalized ethylene polymers comprise 80 to 20 weight percent of the adhesive blend and the weight ratio of first to second functionalized ethylene polymers is from 5:1 to 2:1.

8. The process of claim 7 wherein the metal layer is aluminum.

9. A lamination process for the production of multi-layer structures comprising:
(a) providing a first functionalized ethylene polymer component having an α,β-ethylenically unsaturated carboxylic acid incorporated by grafting or copolymerization;
(b) providing a second functionalized ethylene polymer component having maleic anhydride incorporated by grafting;
(c) combining (a) and (b) with a base resin selected from the group consisting of ethylene homopolymers, copolymers of ethylene and C₃₋₈ α-olefins and copolymers of ethylene and vinyl esters of C₂₋₄ aliphatic acids to form a tie-layer adhesive composition containing 10 to 90 weight percent of a mixture of said first and second functionalized ethylene polymer components and 90 to 10 weight percent base resin, the weight ratio of (a):(b) in said mixture ranging from 8:1 to 1.5:1;
(d) melt blending the tie-layer adhesive composition;
(e) forming the melt blended tie-layer adhesive composition into a film; and
(f) forming a multi-layer laminate wherein the tie-layer adhesive film is disposed between a metal layer and a polyolefin layer.

10. The process of claim 9 wherein the first functionalized ethylene polymer has 3 to 18 weight percent acrylic acid or methacrylic acid incorporated by grafting or copolymerization and the second functionalized ethylene polymer is high density polyethylene or linear low density polyethylene grafted with 0.1 to 5 weight percent maleic anhydride.

11. The process of claim 10 wherein the weight ratio of the first functionalized ethylene polymer to the second functionalized ethylene polymer is from 8:1 to 1.5:1.

12. The process of claim 10 wherein the first functionalized ethylene polymer is an ethylene-acrylic acid copolymer having an acrylic acid content of 5 to 12 weight percent and melt index from 1 to 50 g/10 min.

13. The process of claim 10 wherein the first functionalized ethylene polymer is an ethylene-methacrylic acid copolymer having a methacrylic acid content of 5 to 12 weight percent and melt index from 1 to 50 g/10 min.

14. The process of claim 11 wherein the base resin is low density polyethylene having a density from 0.917 to 0.925 g/cm³ and melt index from 3 to 20 g/10 min.

15. The process of claim 14 wherein the base resin comprises 20 to 80 weight percent of the adhesive blend, the functionalized ethylene polymers comprise 80 to 20 weight percent of the adhesive blend and the weight ratio of first to second functionalized ethylene polymers is from 5:1 to 2:1.

16. The process of claim 15 wherein the metal layer is aluminum.

17. The process of claim 15 wherein the multi-layer laminate has the structure metal/tie-layer adhesive/polyolefin/tie-layer adhesive/metal.

18. The process of claim 17 wherein the metal is aluminum and the polyolefin is polyethylene.

19. The process of claim 7 wherein the multi-layer construction has the structure polyolefin/tie-layer adhesive/metal/tie-layer adhesive/polyolefin.

20. The process of claim 19 wherein the metal is aluminum and the polyolefin is polyethylene.
